(19) United States
(12) Patent Application Publication
(10) Pub. No.: US 2025/0249462 A1
(43) Pub. Date: Aug. 7, 2025

(54) ATTRITOR MILLS AND METHODS FOR PROCESSING MATERIALS USING ATTRITOR MILLS

(71) Applicant: Attritor Mill Limited, Sliema (MT)

(72) Inventors: Mario REALE, Sliema (MT); Luigi REALE, Sliema (MT); Marcello REALE, Sliema (MT)

(21) Appl. No.: 18/856,045

(22) PCT Filed: Apr. 5, 2023
(86) PCT No.: PCT/IB2023/053475

§ 371 Date: Oct. 10, 2024

(30) Foreign Application Priority Data
Apr. 11, 2022 (GB) 2205280.7

(51) Int. Cl. B02C 17/16; B02C 17/18; B02C 18/08

(52) U.S. Cl. CPC B02C 17/163; B02C 17/183; B02C 18/08; B02C 2017/165; B02C 2201/06

(57) ABSTRACT

An attritor mill may include: a grinding container, including a grinding chamber and a rotor within the grinding container. The grinding chamber may be delimited by one or more side walls and a bottom wall. The rotor may include arms extending radially relative to the rotation axis of the rotor. The arms may include first and second arms on one or more levels with reference to a distance from the bottom wall. During normal operation of the attritor mill, a first arm closer to the bottom wall may be radially shorter than a second arm above the first arm. The attritor mill may be configured to treat material by: mixing the material with grinding free bodies in the grinding chamber; and agitating the material and the grinding free bodies by causing the rotor to rotate, so that the first and second arms strike the grinding free bodies.

### FIELD OF THE INVENTION

The present invention relates to an attritor mill and to a process for milling a material to be treated through said mill.

Said attritor mill and respective process are particularly useful for recycling or however processing waste materials such as urban organic or non-organic wastes, agricultural byproducts, plastics, fibrous materials, dirt obtained from street sweeping.

### BACKGROUND ART

Ball or pebble-type mills, often called attritor mills, are by the way known.

These mills are provided with a grinding chamber wherein a rotor, by rotating about a vertical axis, randomly strikes a mass of steel pebbles mixed with other material to be treated.

The latter material is mainly ground as a result of the repeated and very frequent impacts, crushing and rubbing among or anyway against the pebbles.

Attritor mills having the aforementioned features are themselves already known, for example from the patent document U.S. Pat. No. 3,998,938.

The authors of the present invention observed that the flow of the material processed in the grinding chamber and the movements and trajectories of the grinding pebbles or grinding balls in known attritor mills are not very efficient, especially when the material to be processed is organic waste, plastics or fibrous materials.

A purpose of the present invention is to provide an attritor mill or a process to treat waste and other scrape materials in which is more efficient in comparison with known attritor mill, especially concerning the flow of material which is being processed in the grinding chamber and the kinetics of the grinding free pebbles of balls.

### SUMMARY OF THE INVENTION

In a first aspect of the invention, such object is achieved through an attritor mill having the features of claim 1.

In a second aspect of the invention, such object is achieved through a process according to claim 11.

The advantages achievable through the present invention will be more apparent, to the person skilled in the field, from the following detailed description of some particular embodiments provided as non-limiting examples, described with reference to the following schematic figures.

### LIST OF FIGURES

FIG. 1 shows a front view of an attritor mill according to a particular embodiment of the present invention;

FIG. 2 shows a first side view, partly sectioned, of the grinding chamber of the attritor mill of FIG. 1;

FIG. 2A shows an enlarged view of a detail of FIG. 2;

FIG. 3 shows shows a first side view, partly sectioned, of the grinding chamber of the attritor mill of FIG. 1, wherein its rotor is observed in a direction perpendicular to the direction in which it is observed in FIG. 2;

FIG. 3A shows a first magnified detail of FIG. 3;

FIG. 3B shows a second magnified detail of FIG. 3;

FIG. 4 shows a first front view of the milling unit of the attritor mill of FIG. 1, wherein the partial housings of the grinding container are assembled one to another;

FIG. 5 shows a second front view of the milling unit of the attritor mill of FIG. 1, wherein the partial housings of the grinding container are separated one from another;

FIG. 6 shows a third side view, partly sectioned, of the grinding chamber and of the outlet adjusting actuators of the attritor mill of FIG. 1;

FIG. 7 shows a side view of a plant for recycling wastes comprising the attritor mill of FIG. 1;

FIG. 8 shows a front view of the plant of FIG. 7.

### DETAILED DESCRIPTION

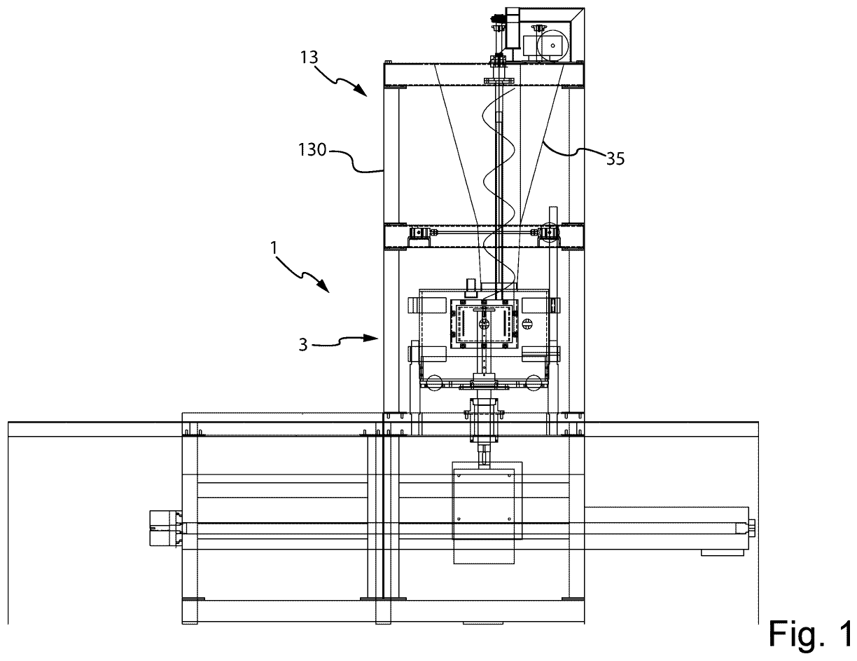

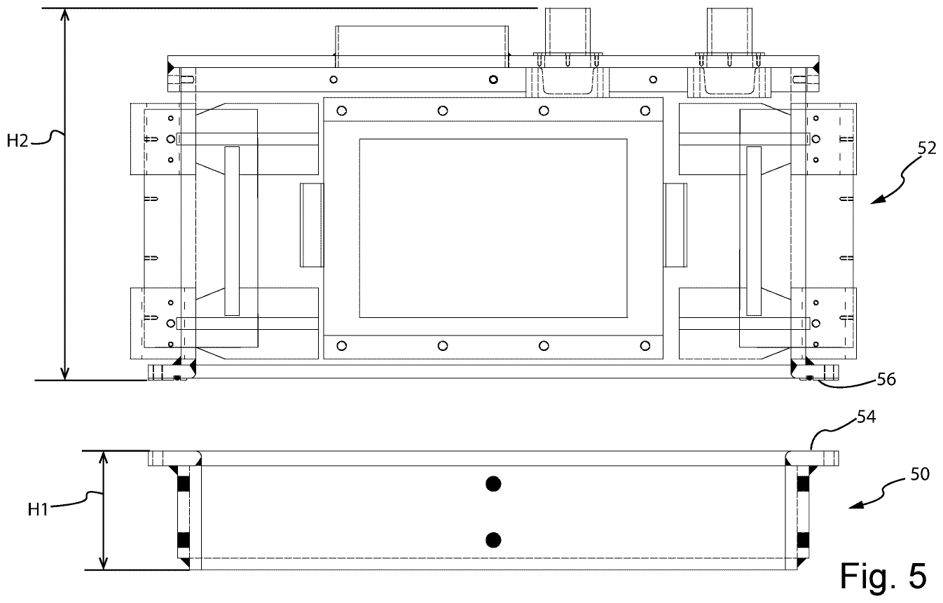

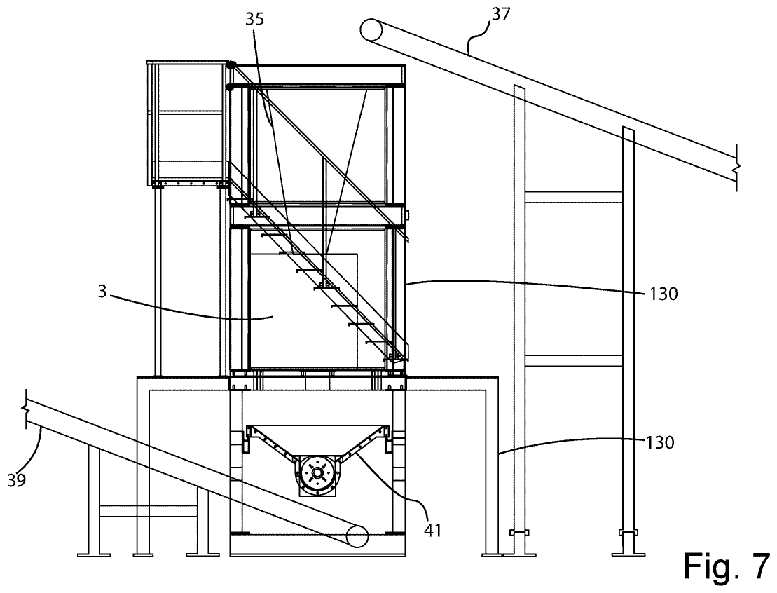

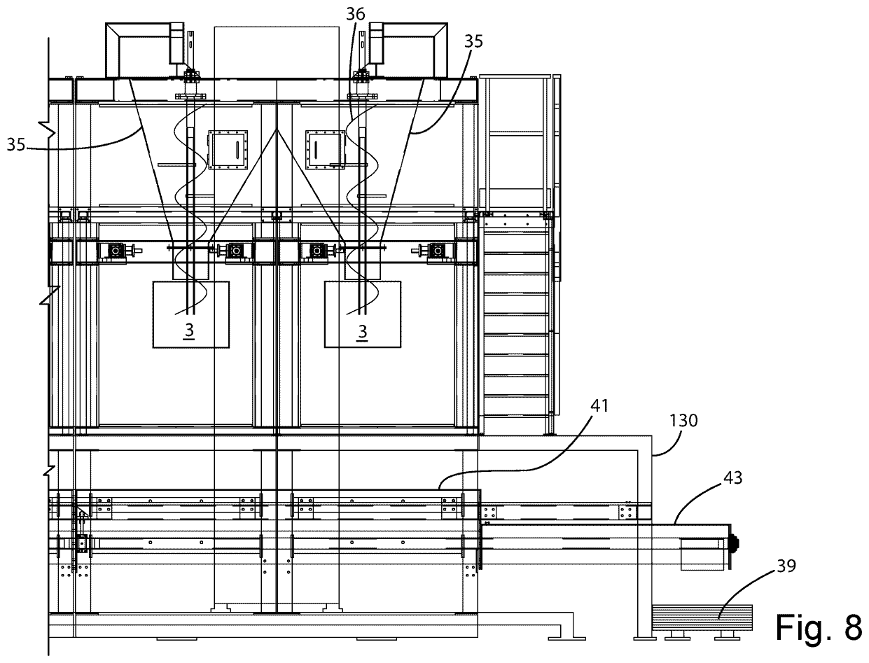

FIGS. 1-8 relate to an attritor mill, indicated with the overall reference 1, according to a first embodiment of the invention.

The attritor mill 1 preferably comprises a load bearing frame 13 which can be made for example up of metal beams 130 (FIG. 1).

The load bearing frame 13 can form for example a lattice (FIG. 1).

The attritor mill 1 comprises a milling unit 3 in its turn comprising:
A) a grinding container 5 forming within itself a grinding chamber 7 delimited by one or more side walls 9; and
B) a rotor 11 arranged within said container 5 and forming a bottom wall 21.

The attritor mill 1 is configured for causing the rotor 11 to rotate around a rotation axis AR which, during normal operation of the mill 1, is preferably vertical or inclined by no more than 450 relative to a vertical direction.

The bottom wall 21 delimits the bottom part of the grinding chamber 7 and substantially extends transversally to the rotation axis AR of the rotor.

Preferably the rotor 11 forms a central shaft 26 extending along the rotation axis AR.

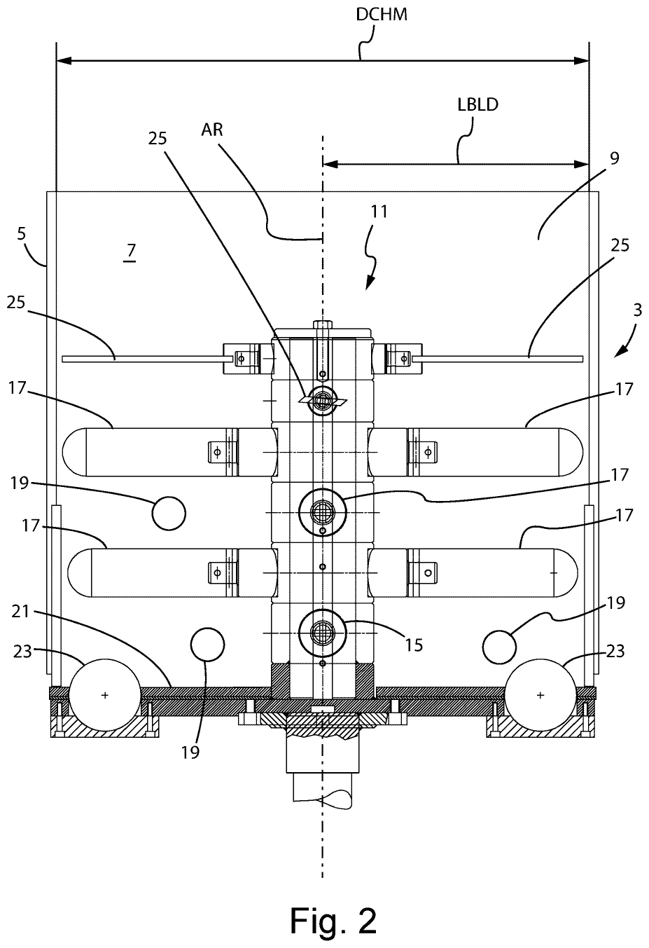

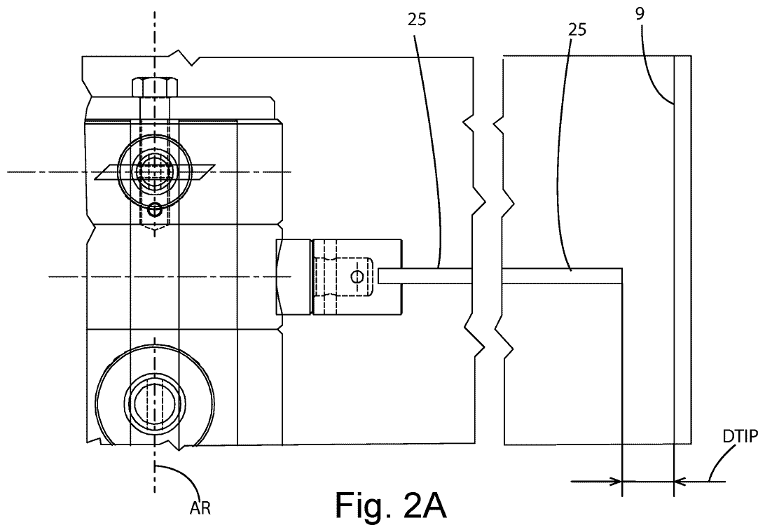

The rotor 11 comprises a plurality of arms 15, 17 extending radially relative to the rotation axis AR of the rotor 11, for example extending radially from the central shaft 26 (FIG. 2, 3).

Said arms 15, 17 are arranged on one or more levels with reference to the distance from the bottom wall 21.

The attritor mill 1 is configured for grinding, reducing, mincing, micronizing and/or drying a material to be treated such as, for example, solid urban waste, food waste, mowing or pruning scraps, vegetable waste from agricultural activity, waste similar to urban waste, FOS (“dry organic fraction”) of urban waste, plastics or mixed urban waste, carrying out the following steps:
C.1) mixing the material to be treated with a plurality of grinding free bodies 19 in the grinding chamber 7;
C.2) agitating the material to be treated and the plurality of grinding free bodies 19 by making the rotor rotate on itself so that its arms 15, 17 hit the grinding free bodies 19 and at least a part of the latter bounce against the walls of the grinding chamber 7 and other grinding free bodies 19, and/or strike the material to be treated.

In particular the attritor mill 1 can dry and dewater organic or other humid waste through squeezing the water contained in the waste under high pressure and vaporizing it tanks to the heat produced by friction in the grinding chamber.

The grinding free bodies 19 can be for example spheres, pebbles, pellets, balls, cobbles, granules of relatively hard materials such as steel, copper or other metals, metal materials, stones.

Preferably the free bodies have an average diameter comprised between 13-25 millimetres, and more preferably comprised between 15-20 millimetres of between 16-20 millimetres or 18-22 millimetres.

At least one first arm 15 closest to the bottom wall 21 is shorter than at least one second arm 17 arranged above the first arm during the normal operation of the attritor mill 1.

Preferably at least one pair of first arms 15 closest to the bottom wall 21 are each of them shorter than at least one third arm 17 arranged above the first arm or arms 15 during the normal operation of the attritor mill 1.

Preferably at least one first arm 15 closest to the bottom wall 21 is shorter than a plurality of second arms 17 arranged above the first arm or arms 15 during the normal operation of the attritor mill 1.

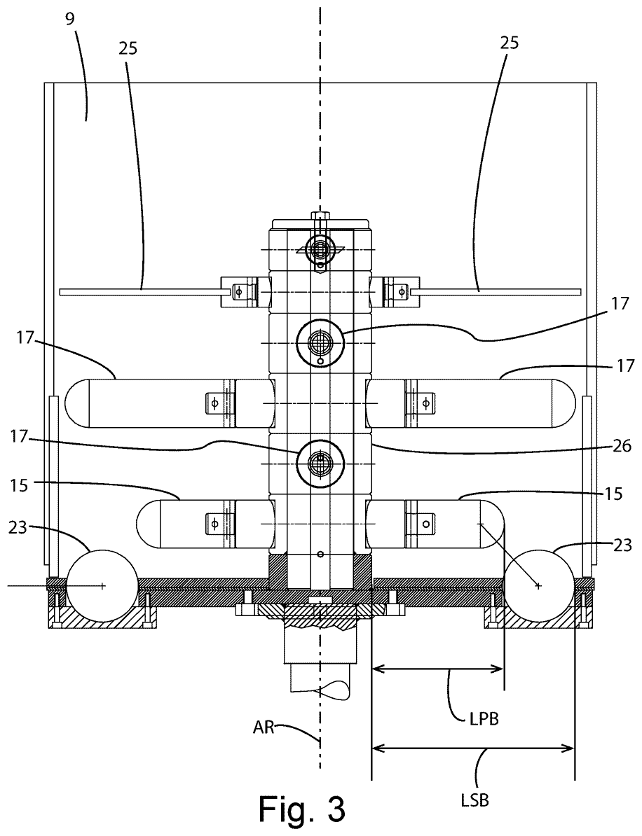

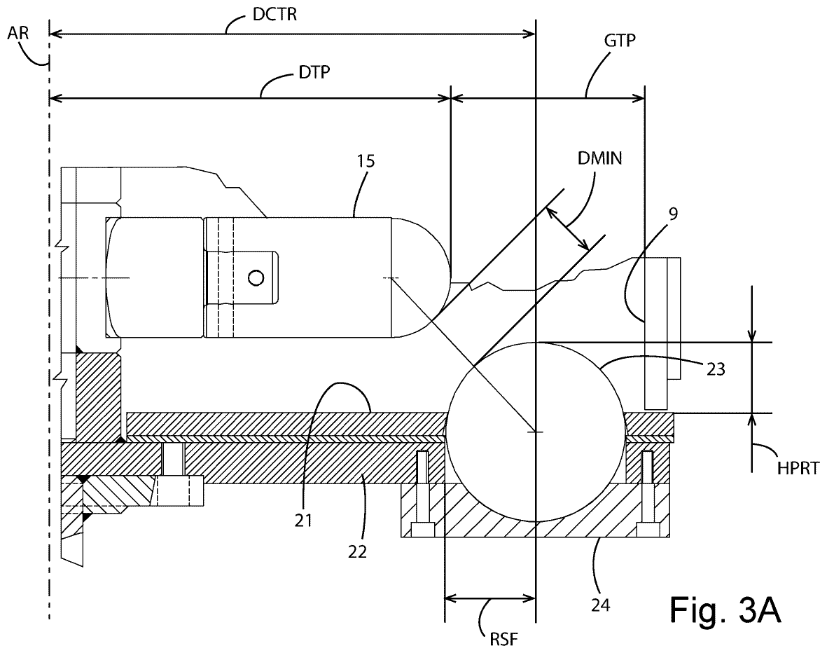

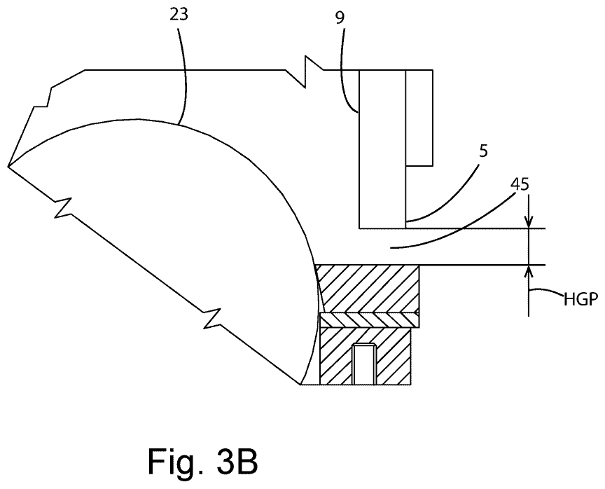

For example at least one pair or first arms 15 is shorter than the second arms 17 (FIG. 3).

Preferably the first arms 15 are closer to the bottom wall 21 than the second arms 17.

The grinding chamber 7 preferably has a cylindrical (FIG. 2, 3, 6) or prysmatic overall shape.

Preferably the radial length DTP of the first arms 15 is smaller than the radial length of the second arms 17 (FIG. 3); for example the radial length DTP of the first arms 15 is comprised between 0.3-0.9 times the radial length DTP of the second arms 17, and more preferably comprised between 0.5-0.8 times or between 0.6-0.8 times.

The radial lengths DTP of the first 15 and second arms 17 can be measured not only from the rotation axis AR but alternatively also from the outer surface of the central shaft 26.

Preferably the radial length DTP of the first 15 and second arms 17 increases with the axial distance of the arms 15, 17 from the bottom wall 21; the radial length DTP can increase for example linearly or in a nonlinear way.

Preferably the first 15 and second arms 17 are configured for milling, grinding, crushing, squashing or however breaking the particles of material to be treated.

To this end preferably at least one of the first 15 and/or second arms 17 or all of them have circular (FIGS. 2, 3), oval, elliptical or more generally smooth and round cross sections, wherein said cross sections are considered in ideal section planes substantially perpendicular to the longitudinal axis of the arms 15, 17.

Still to the above end preferably the outer surface of at least one or all of the first and second arms 15, 17 have a minimum radius of curvature preferably equal to or greater than 5 millimetres, more preferably equal to or greater than 10 millimetres or 20 millimetres, 30 millimetres, 40 millimetres, 50 millimetres, 70 millimetres.

Still to the above end preferably the cross sections of the first and second arms 15, 17, according to ideal planes perpendicular to the longitudinal axis of the respective arm 15, 17 have average radiuses of curvature preferably equal to or greater than 5 millimetres, more preferably equal to or greater than 10 millimetres or 20 millimetres, 30 millimetres, 40 millimetres, 50 millimetres, 70 millimetres.

Still to the above end preferably the outer surface of at least one or all of the first and second arms 15, 17 does not form sharp edges.

Preferably each first arm 15 protrudes from the sides of the central shaft 26 by a length LPB which can be for example comprised between 0.15-0.4 metres or between 0.2-0.3 metres, 0.2-0.25 metres or 0.22-0.24 metres and for example equal to about 0.23 metres.

Preferably each second arm 17 protrudes from the sides of the central shaft 26 by a length LSB which can be for example comprised between 0.25-0.4 metres or between 0.30-0.37 or 0.32-0.36 metres or 0.34-0.36 metres.

Advantageously the distances GTP of the tips, that is of the free ends, of the uppermost second arms 17 from the inner side walls 9 of the grinding chamber 7 are comprised between 0.006-0.03 metres or 0.008-0.02 metres or 0.01-0.013 metres (FIG. 3A)

Advantageously the distances GTP of the tips, that is of the free ends, of the lowermost first arms 15 from the inner side walls 9 are comprised between 0.06-0.2 metres or between 0.09-0.17 metres, between 0.1-0.14 metres, between 0.0125-0.13 metres.

Said distances GTP are particularly effective for enhancing the performances of the attritor mill 1, in particular allowing the material to be treated to flow easier from the top towards the bottom of the grinding chamber 7; the size of the particles of the ground material is also more uniform; the grinding free bodies can be easier kept in flight.

In order to increase the bouncings upwards of the grinding free bodies 19 or the average height—both in time and number of various grinding bodies 19—at which the various grinding free bodies 19 fly during normal operation, and in order to reduce the amount of grinding bodies 19 lying on the bottom wall 21 or however in the lower part of the grinding chamber 7, advantageously at least one supporting protrusion 23 and preferably a plurality of supporting protrusions 23 are provided on the bottom wall 21.

Each supporting protrusion 23 is configured for deviating mainly upwards the grinding free bodies 19, which substantially randomly hit said supporting protrusions 23 (FIGS. 2, 3, ?).

Advantageously each supporting protrusion 23 has a shape selected from the following group: semi-spherical, spherical or dome-shaped cap (FIGS. 2, 3), stud-like protrusions, cylinder-shaped surface portions, smooth crests or ribs or other round and smooth protrusions.

Semi-spherical, spherical or dome-shaped supporting protrusion 23 have a maximum diameter preferably comprised between 10-15 centimetres, and more preferably comprised between 12-13 centimetres, between 12.5-12.8 centimetres or 12.6-12.8 centimetres.

The bottom wall 21 is provided with a number of supporting protrusions 23 comprised between 6-10 and more preferably between 7-9 protrusions 23 or equal to 8 protrusions 23.

The supporting protrusions 23 are arranged on the bottom wall 21 preferably along a single crown or ring, preferably at or close to the outer edge of the bottom wall 21 which can have for example the overall shape of a disc.

Advantageously the distance DCTR of the centre of each supporting protrusion 23 from the rotation axis AR is equal to or greater than the distance DTP of the free end of the first arm 15 or first arms 15 closest to the bottom wall 21.

Advantageously the distance DTP is comprised between the distance DCTR and the distance (DCRT−RSF) wherein RSF is the radius of each supporting protrusion 23.

More preferably the distance DCTR of the centre of each supporting protrusion 23 from the rotation axis AR is greater than the distance DTP of the free end of the first arm 15 or first arms 15 closest to the bottom wall 21; in this regard the ratio DPT/DCTR is preferably comprised between 0.5-0.95 times or between 0.7-0.9 times or between 0.8-0.9 times (FIG. 3A).

The previous provisions of the supporting protrusions 23 and of the arms 15, 17 allow the grinding free bodies 19 be easier lifted, that is easier caused to fly higher, during operation; furthermore enhance the evacuation of the treated material from the grinding chamber 7 and makes easier metal scraps or other metallic parts possibly contained in the material to be treated be prevented from leaving the grinding chamber mixed with the other treated material.

The supporting protrusions 23 are quite effective also alone for obtaining this latter result.

Advantageously each supporting protrusion 23 can be obtained as a relatively compact and at least partly rounded body clamped or interlocked between the bottom plate 22 forming the bottom wall 21 and another clamping body 24 suitable and reversibly fixed to and/or resting against the bottom plate 22 (FIG. 3A).

When the surface of a supporting protrusion 23 facing the grinding chamber 7 is too worn or however deteriorated, the clamping body 24 can be disconnected or however released; each supporting protrusion 23 can be then unblocked, turned on itself so as to face a new and fresh—or however less worn or deteriorated—surface portion towards the grinding chamber 7.

The supporting protrusion 23 can be then blocked again in position fastening or tightening the clamping body against.

This way the supporting protrusions 23 can be used longer before being definitely replaced because excessively worn or deteriorated.

A spherical, semispherical, rounded, globular, ovoidal or pebble-like shape of the protrusions 23 makes this repositioning procedure more efficient and easy.

Advantageously each supporting protrusion 23 protrudes from the bottom wall 21 towards the inner zone of the grinding chamber by a height HPRT equal to or greater than 4 centimetres; the height HPRT is preferably equal to or greater than 5.7 centimetres and possibly comprised between 4-7 centimetres or 5-6 centimetres (FIG. 3A).

Advantageously during normal operation of the attritor mill the minimum distance DMIN between one or more supporting protrusions 23 and the at least one first arm 15 closest to the bottom wall 21 is equal to or smaller than 10 millimetres, more preferably equal to or smaller than 7 millimetres, even more preferably equal to or smaller than 5 millimetres; the minimum distance DMIN is preferably comprised between 2-5-7 millimetres of between 4-6 millimetres or equal to about 5 millimetres.

The distance DMIN is measured along the direction of the ideal line connecting closest points of the outer surfaces of a supporting protrusion 23 and the first arm 15 passing closest to the protrusion 23 at issue when the rotor 11 turns (FIG. 3A).

The previous provisions of the supporting protrusions 23 and of the arms 15, 17 allow the grinding free bodies 19 be easier lifted, that is easier caused to fly more high, during operation.

Advantageously the rotor 11 comprises one or more blades 25 each of which configured for cutting, mincing or chopping the material to be treated, preprocessing such material so as to enhance the efficiency and production rate of the possible next refining operations carried out through the arms 15, 17 and the free grinding bodies 19.

The blades 25 also enhance the distribution of the material to be processed within the grinding chamber 7: in fact the blades 25 chop and mince the material to be treated allowing it to flow easier downwards within the grinding chamber 7, avoiding an excessive reduction of the speed of the free grinding bodies 19.

The next refining operations are a particular process carried out by the attritor mill 1 on some particular wastes or other materials to be processed: when the material to be processed is for example but not only plastics the impacts of the arms 15, 17 and the free grinding bodies 19 produce structural defects within the material to be treated enhancing the waste properties useful in the next processing steps.

Preferably at least one of the blades 25 or each blade 25 extends radially from the central shaft 26 of the rotor 11.

Preferably the blades 25 are equally angularly offset one from another around the rotation axis AR; they can be configured for example so as to form a cross (FIG. 2, 3) or a star.

The blades 25 can be arranged at several levels along the rotation axis AR; in the embodiment of FIG. 2, 3 the blades 25 are arranged at two different levels.

Advantageously during the normal operation at least part of the blades 25 are arranged above the first 15 and second arms 17.

More preferably during the normal operation all of the blades 25 are arranged above the first 15 and second arms 17.

Preferably all of the blades 25 are arranged in an axial section of the rotor 11, in which section the first 15 or second arms 17 are absent.

At least one of the blades 25 or each blade 25 extends radially by a length LBLD preferably equal to or greater than 20 centimetres and/or equal to or greater than 0.2 times the average diameter DCHM of the grinding chamber 7 (FIG. 2).

The length LBLD is preferably comprised between 20-50 centimetres or between 30-45 centimetres.

The length LBLD is preferably comprised between 0.2-0.43 times the average diameter DCHM of the grinding chamber 7, or between 0.3-0.43 times or between 0.40-0.43 times the diameter DHCM.

Alternatively to or in combination with the previous arrangements the distal end of at least one of the blades 25 or each blade 25 is spaced by a minimum distance DTIP from the inner wall 9 of the grinding chamber 7 preferably equal to or smaller than 10-20 millimetres (FIG. 2A)

The rotor 11 can be provided for example with a number of blades comprised between one and four blades (FIG. 2, 3).

The average weight of each particle of the grinding free bodies 19 during normal operation can be comprised for example between 10-40 grams or between 15-35 grams, 16-34 grams, 16-18 grams, 16-17.5 grams, 30-35 grams or 31-34 grams for each grinding free body 19.

The attritor mill is configured for driving the rotor 11 at a rotation speed preferably comprised between 300?1000 rpm and more preferably between 400-800 rpm, 500-800 or 600-800 rpm.

The previous teachings enhance the operation of an attritor mill, allowing the free grinding bodies caused to fly easier and within a wider portion of the grinding chamber 7; the size of the particles of the processed material is also more uniform; also the flow of processed or to be processed material within the grinding chamber is made easier.

When the attritor mill 1 is assembled and normally operating the grinding container 5 extends by an overall height HGC in a direction parallel to the rotation axis AR of the rotor.

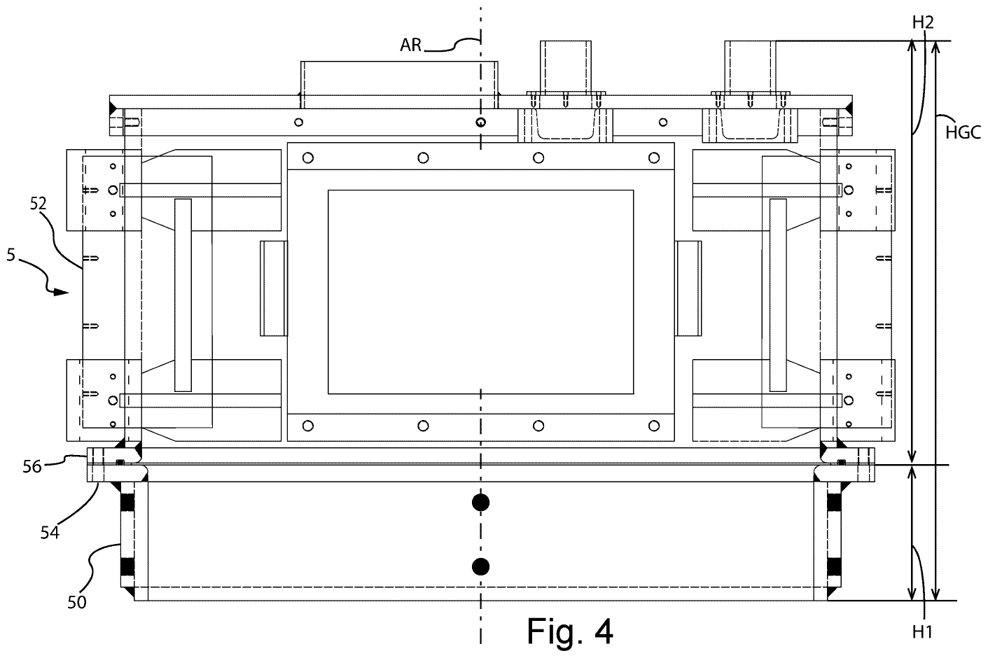

The grinding container 5 can have for example a parallepipedal (FIG. 4, 5), cylindrical, or prysmatic shape.

The grinding container 5 can comprise for example one or more shells made of welded metal plates (FIG. 4, 5).

Advantageously the grinding container 5 comprises at least two partial housings 50, 52 each of which has a height H1, H2 in directions parallel to the rotation axis AR of the rotor.

Each partial housing 50, 52 is advantageously provided with a respective flange 54, 56 allowing the partial housings 50, 52 be connected together (FIG. 4).

To this purpose the flanges 54, 56 are configured for being rested one against another and fixed one to another for example through screws or bolts.

When the grinding container 5 is assembled and the attritor mill 1 normally operates the sum of the heights H1, H2 is preferably equal to the overall height HGC of the grinding container 5 (FIG. 4); in other words preferably the following relation holds

$$HGC = H 1 + H 2 \qquad < 1 >$$

The height H1 or H2 is advantageously comprised between 0.07-0.93 times the overall height HGC of the grinding container 5; more preferably the height H1 or H2 can be comprised between 0.1-0.7 times, between 0.15-0.5 times, between 0.2-0.3 times, between 0.7-0.8 times, between 0.23-0.27 times or between 0.73-0.77 times the overall height HGC.

The previous provisions allow the grinding container 5 be easier and more quickly disassembled for maintenance, as explained with more details hereinafter.

The attritor mill 1 can be provided with one or more material outlets 45 arranged for evacuating the waste or other treated material from the grinding chamber 7.

The one or more material outlets 45 can be arranged for example at the bottom or in the lower section of the grinding chamber 7.

The one or more material outlets 45 can be arranged for example around the outer edge of the bottom wall 21.

The attritor mill 1 can be provided for example with one material outlet 45 made as a gap extending around part of or the whole outer edge of the bottom wall 21 (FIG. 3B).

The attritor mill 1 can be arranged for adjusting the width and/or the overall clearance cross sections of the outlet or outlets 45.

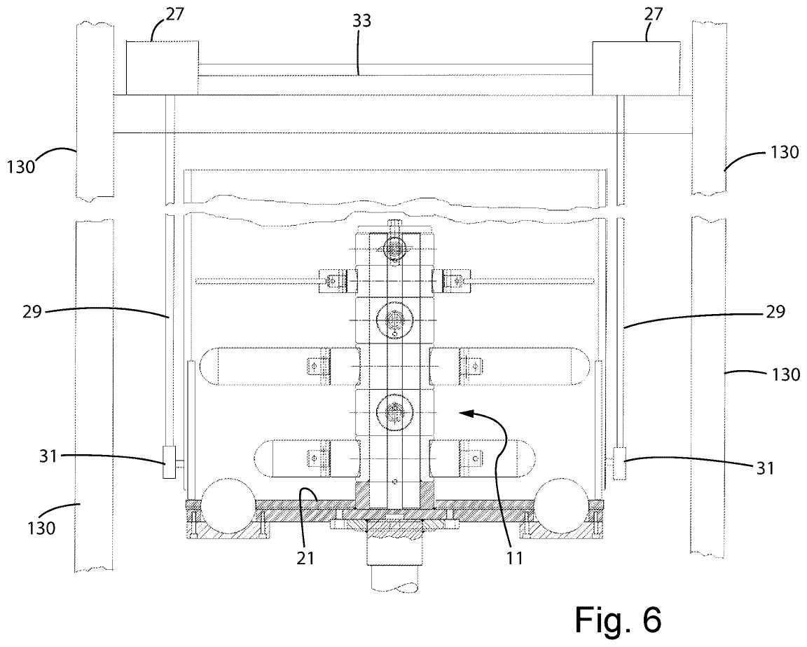

To this end the attritor mill 1 can provided with one or more outlet adjusting actuators 27 arranged for adjusting the width and/or the overall clearance cross sections of the outlet or outlets 45, preferably adjusting the height of the lower edge of the side walls 9 of the grinding chamber 7 relative to the bottom wall 21 (FIG. 6).

Each outlet adjusting actuators 27 can comprise for example a jack arranged for adjusting the height of the lower edge of the side walls 9 of the grinding chamber 7 relative to the bottom wall 21 (FIG. 6).

Each jack or other outlet adjusting actuator 27 can be driven for example by a suitable electrical, hydraulic or pneumatic motor (not shown).

The side walls 9 can be hung to one or more jacks or other outlet adjusting actuators 27 (FIG. 6) or rest on one or more jack or other outlet adjusting actuators 27.

More particularly the side walls 9 can be hung to one or more tie rods 29 arranged for being lifted and/or lowered by one or more jacks or other outlet adjusting actuators 27 (FIG. 6).

The attritor mill 1 can be provided for example with four tie rods 29 arranged at the corners of an ideal square or rectangle lying in a horizontal plane.

Each tie rod 29 can be for example a threaded bar arranged for being reversibly screwed in and unscrewed in a suitable nut screw drive by a respective jack or other outlet adjusting actuator 27.

Advantageously each jack or other outlet adjusting actuator 27 is arranged for varying in a substantially stepless way the width and/or the overall clearance cross sections of the outlet or outlets 45.

Alternatively each jack or other outlet adjusting actuator 27 is arranged for varying the width and/or the overall clearance cross sections of the outlet or outlets 45 in a discrete way, for example so as to make the width and/or the overall clearance cross sections of the outlet or outlets 45 equal or similar to a value chosen from a predetermined and countable set; such predetermined and countable set of the possible width and/or the overall clearance cross sections values can comprise for example 5 or 10 or 20 or 100 or 1000 or more steps, that is 5 or 10 or 20 or 100 or 1000 or more possible discretized values.

The one or more jacks or other outlet adjusting actuators 27 can be fixed to the load bearing frame 13, for example to one or more crossbars or other metal beams 130 (FIG. 6).

The jacks 27 allow the granulometry of the processed material be adjusted and quickly unblock pieces of the processed material stuck in the outlet or outlets 45, avoiding clogging of the outlets 45, without stopping the operation of the attritor mill 1.

Furthermore the outlet adjusting actuators 27 allow the bottom wall 21, the rotor 11 be easier disassembled as well as interlocked or stuck parts, if any, be easier disassembled.

The attritor mill 1 can be provided for example with a charging hopper 35 configured for dropping organic waste or another material to be treated in the grinding chamber 7 of a respective milling unit 3 (FIG. 1, 7, 8).

The charging hopper 35 can have for example a substantially conical shape (FIG. 1, 7, 8).

The charging hopper 35 can be fed with organic waste or another material for example through a feeding conveyor belt 37.

The charging hopper 35 can be provided with an auger 36 configured for turning around an axis which can be for example substantially vertical so as to advance the material to be treated towards the grinding chamber 7 easier and more regularly, or however better controlled.

The material processed by each milling unit 3 and coming from it can be evacuated for example through an evacuation conveyor belt 39.

The material processed by each milling unit 3 and coming from it can be for example collected in an evacuation hopper 41.

The evacuation hopper 41 can be provided with an auger 43 configured for turning around an axis substantially horizontal and for collecting and bringing the processed material fallen at the bottom of the evacuation hopper 41 to or towards the evacuation conveyor belt 39.

Some examples of possible use and operation of the attritor mill 1 will now be described.

The organic waste or other material to be treated can be dropped from the top end of the feeding conveyor belt 37 into the charging hopper 35, and pushed forward by the auger 36 possibly arranged in the hopper 35.

The material to be treated falls in or however enters the grinding chamber 7, in which a suitable number of grinding free bodies 19 have been previously introduced.

When falling from above the material to be treated is roughly cut, chopped or minced by the blades 25 the rotor 11 can be possibly provided with.

As already described the rotor 11 preferably rotates at such a speed which prevents the pebbles, balls or other grinding free bodies 19 from hitting and damaging the blades 25 and more generally from flying in the section of the chamber 7 where the blades 25 are.

Still falling downwards the material to be treated is further hit, grinded, crushed or squashed by the arms 15, 17 and the grinding free bodies 19; the average granulometry of the material to be treated is further reduced until the material exits for example through the outlet gap 45 (FIG. 3B).

The ground material can then fall for example in the evacuation hopper 41 where is collected and transferred by the auger 43 towards the evacuation conveyor belt 39.

Wear is usually more severe in the lower part of the grinding chamber 7.

When the bottom wall 21 of the rotor and/or the lower part of the inner side walls 9 of the grinding chamber 7 are too worn or however damaged, they can be replaced for example disconnecting the flanges 54, 56 and/or more generally the partial housings 50, 52 one from another, for example unscrewing the bolts, if any, connecting the two flanges 54, 56 one with another.

The upper partial housing 52 can then be lifted for example with a forklift truck and removed from the lower partial housing 50 and the rotor 11.

The lower housing 50, the bottom wall 21 of the rotor and/or the whole rotor 11 can then quickly replaced, and the attritor mill 1 quickly reassembled and made able to operate again; this way operation of the attritor mill 1 can be stopped for example by one and half hour or even less.

It is pointed out that stopping the operation of recycling and waste managements plants is in general very critical and great care is adopted for avoiding it.

Furthermore making the grinding container 5 reversibly and easily splittable in two or more partial housings 50, 52 allows the lower partial housing 50 be easier made more wear resistant and more generally more resistant to damages and mechanical stresses for example through coatings of suitable wear resistant materials.

Making the grinding container 5 reversibly and easily splittable in two or more partial housings 50, 52 allows also the overall height be reduced of the load bearing frame 13 as well as reducing vibrations thereof.

In fact during replacement the upper partial housing 52 needs be replaced—for example by the abovementioned lift truck—by a smaller stroke than that required for lifting and removing the whole grinding container 5 from the rotor 11 if the first would be formed by a monolithic single piece, since the height H2 of the upper partial housing 52 is smaller than the sum of the heights H1+H2 of the partial housings 50, 52 assembled together.

The shorter lifting stroke of the upper partial housing 52 allows the overall height of the load bearing frame 13 be reduced for example by 0.5 metres.

A shorter load bearing frame 13 is desirable since it amplifies less the vibrations produced by the milling unit 3 during operation.

The milling unit 3 is often arranged at considerable heights because of the encumbrance of other parts or devices to be arranged below, such as the evacuation hopper 41 and/or the evacuation conveyor belt 39; hence even if the load bearing frame 13 can be often several metres tall, even an apparently small reduction of the height of the milling unit 3 greatly reduces the vibrations in the load bearing frame 13.

The previously described embodiments can undergo various changes and variations without departing from the scope of the present invention.

For example in an embodiment the width of the one or more material outlets 45 can be adjusted not just varying the height of the walls of the grinding chamber 7 relative to the load bearing frame 13 but also by adjusting the height of the bottom wall 21 respective to the bearing frame 13.

A third aspect of the present invention relates to an attritor mill (1) comprising:
A) a grinding container (5) that forms within itself a grinding chamber (7) delimited by one or more side walls (13); and
B) a rotor (11) arranged within said grinding container (5) and forming a bottom wall (21);
and wherein:
C) the bottom wall (21) delimits the bottom part of the grinding chamber (7) and substantially extends transversally to the rotation axis (AR) of the rotor (11);
D) the rotor (11) comprises a plurality of arms (15, 17) extending radially relative to the rotation axis (AR) of the rotor (11), said arms (15, 15) comprised at least one first arm (15) and at least one second arm (17) and are arranged on one or more levels with reference to the distance from the bottom wall (21), and the attritor mill (1) is configured for grinding, reducing, mincing or micronizing a material to be treated such as, for example, solid urban waste, food waste, mowing or pruning scraps, vegetable waste from agricultural activity, waste similar to urban waste, FOS (“dry organic fraction”) of urban waste carrying out the following steps:
D.1) mixing the material to be treated with a plurality of grinding free bodies (19) in the grinding chamber (7);
D.2) agitating the material to be treated and the plurality of grinding free bodies (19) by causing the rotor (11) rotate on itself so that its first (15) and second arms (17) strike the grinding free bodies (19) and at least a part of said grinding free bodies (19) bounce against the walls of the grinding chamber (7) and other grinding free bodies (19), and/or strike the material to be treated;
and wherein:—the grinding container (5) comprises at least two partial housings (50, 52) each of which extends by a height (H1, H2) in directions parallel to the rotation axis (AR) of the rotor (11)
   the at least two partial housings (50, 52) are configured for being reversibly assembled and disassembled one with another for example through bolts, screws or other threaded connections, bajonet connections, latches or other interlockings;
   when the grinding container (5) is assembled and the attritor mill (1) normally operates the sum of the heights (H1, H2) of the partial housings (50, 52) is equal to the overall height (HGC) of the grinding container (5);
   the height (H1, H2) of at least one of the partial housings (50, 52) is comprised between 0.07-0.93 times the overall height (HGC) of the grinding container 5.

A fourth aspect of the present invention relates to an attritor mill (1) comprising:
A) a grinding container (5) that forms within itself a grinding chamber (7) delimited by one or more side walls (13); and
B) a rotor (11) arranged within said grinding container (5) and forming a bottom wall (21);
and wherein:
C) the bottom wall (21) delimits the bottom part of the grinding chamber (7) and substantially extends transversally to the rotation axis (AR) of the rotor (11);
D) the rotor (11) comprises a plurality of arms (15, 17) extending radially relative to the rotation axis (AR) of the rotor (11), said arms (15, 15) comprised at least one first arm (15) and at least one second arm (17) and are arranged on one or more levels with reference to the distance from the bottom wall (21), and the attritor mill (1) is configured for grinding, reducing, mincing or micronizing a material to be treated such as, for example, solid urban waste, food waste, mowing or pruning scraps, vegetable waste from agricultural activity, waste similar to urban waste, FOS (“dry organic fraction”) of urban waste carrying out the following steps:
D.1) mixing the material to be treated with a plurality of grinding free bodies (19) in the grinding chamber (7);
D.2) agitating the material to be treated and the plurality of grinding free bodies (19) by causing the rotor (11) rotate on itself so that its first (15) and second arms (17) strike the grinding free bodies (19) and at least a part of said grinding free bodies (19) bounce against the walls of the grinding chamber (7) and other grinding free bodies (19), and/or strike the material to be treated;
and wherein the attritor mill (1) further comprises: one or more material outlets (45) arranged for evacuating the waste or other treated material from the grinding chamber (7); and
   one or more outlet adjusting actuators (27) arranged for adjusting the width and/or the overall clearance cross sections of the outlet or outlets (45) while the attritor mill (1) operates.

A fifth aspect of the present invention relates to an attritor mill (1) comprising:
A) a grinding container (5) that forms within itself a grinding chamber (7) delimited by one or more side walls (13); and
B) a rotor (11) arranged within said grinding container (5) and forming a bottom wall (21);
and wherein:
C) the bottom wall (21) delimits the bottom part of the grinding chamber (7) and substantially extends transversally to the rotation axis (AR) of the rotor (11);
D) the rotor (11) comprises a plurality of arms (15, 17) extending radially relative to the rotation axis (AR) of the rotor (11), said arms (15, 15) comprised at least one first arm (15) and at least one second arm (17) and are arranged on one or more levels with reference to the distance from the bottom wall (21), and the attritor mill (1) is configured for grinding, reducing, mincing or micronizing a material to be treated such as, for example, solid urban waste, food waste, mowing or pruning scraps, vegetable waste from agricultural activity, waste similar to urban waste, FOS (“dry organic fraction”) of urban waste carrying out the following steps:
D.1) mixing the material to be treated with a plurality of grinding free bodies (19) in the grinding chamber (7);
D.2) agitating the material to be treated and the plurality of grinding free bodies (19) by causing the rotor (11) rotate on itself so that its first (15) and second arms (17) strike the grinding free bodies (19) and at least a part of said grinding free bodies (19) bounce against the walls of the grinding chamber (7) and other grinding free bodies (19), and/or strike the material to be treated;
and wherein the rotor (11) comprises one or more blades (25) each of which configured for cutting, mincing or chopping the material to be treated.

A sixth aspect of the present invention relates to a process for processing a material, comprising the following steps:
S.11.1) providing an attritor mill (1) at least according to the fifth aspect of the present invention;
S.11.2) rotating the rotor (11) around itself and around a rotation axis (AR) which is substantially vertical or inclined by no more than 45° relative to a vertical direction;
wherein the one or more blades (25) are arranged above the first (15) and second arms (17) during the normal operation of the attritor mill 81).

A seventh aspect of the present invention relates to a process for processing a material, comprising the following steps:
S.12.1) providing an attritor mill (1) at least according to the third and/or fourth aspect of the present invention;
S.12.2) mixing the material to be treated with a plurality of grinding free bodies (19) in the grinding chamber (7);
S.12.3) agitating the material to be treated and the plurality of grinding free bodies (19) by causing the rotor (11) rotate on itself so that its first (15) and second arms (17) strike the grinding free bodies (19) and at least a part of said grinding free bodies (19) bounce against the walls of the grinding chamber (7) and other grinding free bodies (19), and/or strike the material to be treated;
wherein the material to be processed comprises one or more materials chosen from the following group: urban organic or non-organic wastes, plastics, fibrous materials

Every reference in this description to “an embodiment”, “an embodiment example” means that a particular feature or structure described in relation to such embodiment is included in at least one embodiment of the invention and in particular in a specific variant of the invention as defined in a main claim.

The fact that such expressions appear in various passages of the description does not imply that they are necessarily referred solely to the same embodiment.

In addition, when a feature, element or structure is described in relation to a particular embodiment, it is observed that it is within the competence of the person skilled in the art to apply such feature, element or structure to other embodiments.

Numerical references that differ only in the different superscripts, e.g. 21′, 21″, 21′″ when not otherwise specified indicate different variants of an element called in the same way.

Furthermore, all of the details can be replaced by technically equivalent elements.

For example, the materials used, as well as the dimensions thereof, can be of any type according to the technical requirements.

It must be understood that an expression of the type “A comprises B, C, D” or “A is formed by B, C, D” also comprises and describes the particular case in which “A is made up of B, C, D”.

The expression “A comprises an element B” unless otherwise specified is to be understood as “A comprises one or more elements B”.

References to a second, third, fourth entity and so on do not necessarily imply the existence of a first, second and third entity respectively but they are simply a conventional name to indicate that an nth entity might be different and distinct from any other 1, 2th . . . (n−1), (n+1)-th entities, if they existed.

The examples and lists of possible variants of the present application are to be construed as non-exhaustive lists.

1. An attritor mill, comprising:
a grinding container that forms within itself a grinding chamber delimited by one or more side walls; and
a rotor arranged within the grinding container and forming a bottom wall;
wherein the bottom wall delimits a bottom part of the grinding chamber and substantially extends transversally to a rotation axis of the rotor,
wherein the rotor comprises a plurality of arms extending radially relative to the rotation axis of the rotor, wherein the arms comprise at least one first arm and at least one second arm and are arranged on one or more levels with reference to a distance from the bottom wall, and wherein the attritor mill is configured for grinding, reducing, mincing, or micronizing material to be treated by:
mixing the material to be treated with a plurality of grinding free bodies in the grinding chamber; and
agitating the material to be treated and the plurality of grinding free bodies by causing the rotor to rotate on itself so that the at least one first arm and the at least one second arm strike the grinding free bodies, at least a part of the grinding free bodies bounce against the walls of the grinding chamber, bounce against others of the grinding free bodies, and/or strike the material to be treated;
wherein the at least one first arm closest to the bottom wall is shorter than the at least one second arm arranged above the at least one first arm during normal operation of the attritor mill.

2. The attritor mill of claim 1, wherein the at least one first arm closest to the bottom wall is shorter than the at least one second arm above the at least one first arm during the normal operation of the attritor mill.

3. The attritor mill of claim 1, wherein at least one first arm closest to the bottom wall is shorter than a plurality of the second arms above the at least one first arm during the normal operation of the attritor mill.

4. The attritor mill of claim 1, wherein the bottom wall forms one or more supporting protrusions, wherein each of the one or more supporting protrusions is configured to deviate, mostly upward, the grinding free bodies that strike at least one of the one or more supporting protrusions, and wherein at least some of the one or more supporting protrusions have a shape selected from the following group: semi-spherical, stud-like, other rounded protrusion, or a rounded crest, and
wherein during the normal operation of the attritor mill, a minimum distance between the one or more supporting protrusions and the at least one first arm closest to the bottom wall is less than or equal to 2 millimeters (mm).

5. The attritor mill of claim 1, wherein the rotor comprises one or more blades, and
wherein each of the one or more blades is configured to cut, mince, and/or chop the material to be treated.

6. The attritor mill of claim 1, wherein the at least one first arm and the at least one second arm have substantially smooth surfaces configured to comminute, pulverize, or otherwise reduce granulometry of the material to be treated, or wherein the at least one first arm and the at least one second arm have substantially smooth surfaces configured to scutch the material to be treated mainly by pressing, milling, grinding, crushing, squashing, or otherwise breaking particles of the material to be treated rather than cutting or shearing the particles of the material to be treated.

7. The attritor mill of claim 1, wherein the grinding container comprises at least two partial housings, each of which extends by a height in directions parallel to the rotation axis of the rotor,
wherein the at least two partial housings are configured to be reversibly assembled and disassembled one with another,
wherein when the grinding container is assembled and the attritor mill normally operates, a sum of the heights of the at least two partial housings is equal to an overall height of the grinding container, and
wherein the height of at least one of the at least two partial housings is greater than or equal to 0.07 times the overall height of the grinding container and less than or equal to 0.93 times the overall height of the grinding container.

8. The attritor mill of claim 1, further comprising:
one or more material outlets configured to evacuate waste or other treated material from the grinding chambers; and
one or more outlet adjusting actuators configured to adjust a width and/or overall clearance cross sections of the one or more material outlets while the attritor mill operates.

9. The attritor mill of claim 8, wherein the one or more outlet adjusting actuators are configured to adjust the width and/or the overall clearance cross sections of the one or more material outlets by adjusting a height of the one or more side walls of the grinding chamber relative to the bottom wall of the grinding chamber.

10. The attritor mill of claim 8, further comprising:
a material outlet of the one or more material outlets formed as a gap extending around part of or an entire outer edge of the bottom wall.

11. A method for processing material to be treated, the method comprising:
providing the attritor mill of claim 5; and
rotating the rotor around the rotation axis of the rotor, which is substantially vertical or inclined by no more than 45° relative to a vertical direction;
wherein the one or more blades are above the at least one first arm and the at least one second arm during the normal operation of the attritor mill.

12. A method for processing material to be treated, the method comprising:
providing the attritor mill of claim 1;
mixing the material to be treated with the plurality of grinding free bodies in the grinding chamber; and
agitating the material to be treated and the plurality of grinding free bodies by causing the rotor to rotate on itself so that the at least one first arm and the at least one second arm strike the grinding free bodies, at least the part of the grinding free bodies bounce against the walls of the grinding chamber, bounce against others of the grinding free bodies, and/or strike the material to be treated;
wherein the material to be treated comprises one or more materials chosen from the following group: urban organic wastes, urban non-organic wastes, plastics, or fibrous materials.

13. An attritor mill, comprising:
a grinding container, comprising:
a grinding chamber; and
a rotor within the grinding container;
wherein the grinding chamber is delimited by one or more side walls and a bottom wall,
wherein a lower portion of the rotor forms the bottom wall,
wherein the bottom wall extends transversally to a rotation axis of the rotor,
wherein the rotor comprises a plurality of arms extending radially relative to the rotation axis of the rotor,
wherein the plurality of arms comprises one or more first arms and one or more second arms,
wherein the one or more first arms and the one or more second arms are on one or more levels with reference to a distance from the bottom wall,
wherein at least one of the one or more first arms is closer to the bottom wall than the one or more second arms,
wherein during normal operation of the attritor mill, the at least one of the one or more first arms that is closer to the bottom wall is radially shorter than at least one of the one or more second arms above the at least one of the one or more first arms, and
wherein the attritor mill is configured to grind, reduce, mince, and/or micronize material to be treated by:
mixing the material to be treated with a plurality of grinding free bodies in the grinding chamber; and
agitating the material to be treated and the grinding free bodies by causing the rotor to rotate, so that the one or more first arms and the one or more second arms strike the grinding free bodies, causing at least some of the grinding free bodies to bounce against the side walls, to bounce against others of the grinding free bodies, and/or to strike the material to be treated.

14. A method for processing material to be treated, the method comprising:
providing the attritor mill of claim 13;
mixing the material to be treated with the grinding free bodies in the grinding chamber; and
agitating the material to be treated and the grinding free bodies by causing the rotor to rotate, so that the one or more first arms and the one or more second arms strike the grinding free bodies, causing at least some of the grinding free bodies to bounce against the one or more side walls, to bounce against others of the grinding free bodies, and/or to strike the material to be treated.

15. The method of claim 14, wherein the material to be treated comprises one or more of urban organic wastes, urban non-organic wastes, plastics, or fibrous materials.

16. A plant for recycling waste, the plant comprising:
the attritor mill of claim 13.

17. An attritor mill, comprising:
a grinding container, comprising:
a grinding chamber delimited by one or more side walls and a bottom wall; and
a rotor in the grinding container;
wherein the rotor comprises a plurality of arms extending radially relative to a rotation axis of the rotor,
wherein the arms are on one or more levels with reference to a distance from the bottom wall,
wherein one or more of the arms is on a level closer to the bottom wall than any of the other arms,
wherein during normal operation of the attritor mill, the one or more of the arms on the level closer to the bottom wall than any of the other arms is radially shorter than any of the other arms, and
wherein the attritor mill is configured to grind, reduce, mince, and/or micronize material to be treated by:
mixing the material to be treated with a plurality of grinding free bodies in the grinding chamber; and
agitating the material to be treated and the grinding free bodies by causing the rotor to rotate, so that the arms strike the grinding free bodies, causing at least some of the grinding free bodies to bounce against the side walls, to bounce against others of the grinding free bodies, and/or to strike the material to be treated.

18. A method for processing material to be treated, the method comprising:
providing the attritor mill of claim 17;
mixing the material to be treated with the grinding free bodies in the grinding chamber; and
agitating the material to be treated and the grinding free bodies by causing the rotor to rotate, so that the arms strike the grinding free bodies, causing at least some of the grinding free bodies to bounce against the one or more side walls, to bounce against others of the grinding free bodies, and/or to strike the material to be treated.

19. The method of claim 18, wherein the material to be treated comprises one or more of urban organic wastes, urban non-organic wastes, plastics, or fibrous materials.

20. A plant for recycling waste, the plant comprising:
the attritor mill of claim 17.
